(19) United States
(12) Patent Application Publication
(10) Pub. No.: US 2005/0141158 A1
(43) Pub. Date: Jun. 30, 2005

(54) Overvoltage projection circuit

(76) Inventors: Sakda Sae-Ueng, Samutprakarn (TH); Phakphum Promsopha, Samutprakarn (TH); Ming Chun Xu, Samutprakarn (TH)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 10/870,499

(22) Filed: Jun. 17, 2004

(30) Foreign Application Priority Data
Dec. 31, 2003 (TW) 092137770

(51) Int. Cl. H02M 5/42

(52) U.S. Cl. 361/91.1

(57) ABSTRACT

An overvoltage protection circuit for use with a power supply is proposed, wherein the power supply includes a voltage supply circuit and a diode having a first electrode and a second electrode. The overvoltage protection circuit is used to stop or reduce the output voltage of the voltage supply circuit when the output voltage of the voltage supply circuit exceeds its maximum output voltage rating. The overvoltage protection circuit comprises a first comparator for detecting a first voltage at the first electrode of the diode and outputting a first detecting signal in response to the comparison between the first voltage and the maximum output voltage rating, a second comparator for detecting a second voltage at the second electrode of the diode and outputting a second detecting signal in response to the comparison between the second voltage and the maximum output voltage rating, and a logic circuit for stopping or reducing the output voltage of the voltage supply circuit when both of the first voltage and the second voltage are higher than the maximum output voltage rating.

### FIELD OF THE INVENTION

The present invention is related to an overvoltage protection circuit, and more particularly to an overvoltage protection circuit for use in a power supply.

### BACKGROUND OF THE INVENTION

With the incessant progress of technology, a computer has become a must-have appliance used prevalently in daily life. However, a computer needs electric power to start its operation as an ordinary electric appliance. To provide sufficient electric power for a computer, a power supply of which the main function is to convert an alternating current (AC) power supplied from an inlet into a direct current power (DC) for use by a computer, is contrived. A well-regulated power supply is required to comply with some industrial standards, for example, reliabilities, functionality specifications, safeguarding specifications, safety regulations, EMI compatibility, and other miscellaneous requirements.

When the feedback control circuit or other internal components of a power supply are impaired during operation and thus create an output voltage being higher than its maximum output voltage rating, the output voltage of power supply has to be restrained by a protection circuit in order to keep the circuit components of the load from being damaged. Such fail-safe utility that can restrain the output voltage of a power supply from increasing unlimitedly is referred to as overvoltage protection circuit, or OVP circuit.

The OVP function plays an extremely important role for a sensitive load, such as a central processing unit (CPU), memory, or a logic circuit. If a sensitive load is powered by a voltage being higher than its maximum tolerance, that would result in permanent damage and cause significant monetary losses.

Referring to FIG. 1, a schematic graph showing the output voltage waveform of a power supply provided with an OVP function is depicted. As can be understood from FIG. 1, the output voltage Vout will continue to rise up at time t1 and will be restrained from outputting a voltage being higher than a maximum output voltage rating V2 at time t2, and thereby protect the internal circuit components of the load to which the power supply connects.

In case that a power supply of a computer is out of order and cannot provide electric power for output, the computer is not possible to bring itself into action. In order to prevent the computer from becoming unworkable due to the failure of the internal power supply, a redundant power supply is invented to address this deficiency. A computer user can directly extract a redundant power supply from a computer host when the electric power is supplying to the computer host. In other words, the power supply of a computer host can be assured by a redundant power supply, even if the power supply of the computer cannot maintain a normal power supplying state. Besides, a portion of the backup power supplies or malfunctioned power supplies can be removed or replaced with new power supplies during the operation period of the computer. Generally, a computer system will be equipped with at least two redundant power supplies. Under normal condition, the required power supply amount of the computer system will be shared equally by the redundant power supplies. In the event that one of the redundant power supplies is impaired, the power supply can be changed to be provided by the other redundant power supply.

Referring to FIG. 2a, a circuit block diagram of a redundant power supply system according to the prior art is shown. As indicated in FIG. 2a, the redundant power supply 20 is configured to receive an input power from an input power source 22 and convert the input power into an output voltage tailored to power a load 24. The redundant power supply 20 includes n power supplies 21 and is capable of transferring its output voltage having a DC characteristic to the load 24, wherein each of the power supplies 21 includes a PWM (pulse-width modulation) controller 211, a filter 212, a diode 213, and an OVP comparator 214.

The PWM controller 211 is used to perform a PWM operation to the input power received from the input power source 22. The filter 212 is a low-pass filter (LPF) that performs a filtering operation to the modulated pulse signals outputted from the PWM controller 211 and provides a filtered DC voltage for output. The filtered output DC voltage is transferred to the load 24 through the diode 213 and an output voltage bus 23.

The OVP comparator 214 is used to detect the output voltage provided by the filter 212 and determines whether the output voltage exceeds a maximum output voltage rating. If the output voltage exceeds the maximum output voltage rating, the OVP function will be activated to stop the PWM controller 211 from providing an output voltage, such that the internal circuit components of the load 24 can be protected.

Referring to FIG. 2b, a signal waveform diagram showing the output voltage being detected by an OVP comparator of a conventional power supply is illustrated. As shown, the bottom horizontal line indicated by a symbol V1 represents the desired normal output voltage a load requires to sustain its operation. The horizontal line indicated by a symbol V2 represents the noise margin of about ±0.6V that is generated due to the interference in the internal circuit components of the power supply. The horizontal line indicated by a symbol V3 represents the overshoot margin that is generally rated at three percents of the output voltage V1. The horizontal line indicated by a symbol ΔVf represents the voltage drop caused by the forward-biased characteristics of the diode (about 0.2V). As shown in FIG. 2c, the total margin equals to V2+V3+ΔVf, and the output voltage Vout detected by the OVP comparator equals to V1+V2+V3+ΔVf.

In the case that the load 24 requires an output voltage of 12 volts to sustain its operation, the maximum output voltage rating of a power supply generally ranges from 13.5V to 15V. Based on this rationale, as shown in FIG. 2b, if the desired normal output voltage V1 is 12.2 volts, the noise margin V2 is 60 mV, the overshoot margin V3 is 0.1 Volt, the voltage drop ΔVf of the forward-biased diode is 0.2V, and then the output voltage Vout of the power supply should be V1+V2+V3+ΔVf=12.2+0.06+0.1+0.2=12.56, which is limited within the maximum output voltage rating of 13.5V to 15V. Under this condition, there will not cause overvoltage problems.

However, if the load 24 is quite voltage-sensitive and belongs to a specifically-designed system, the gap between the desired normal output voltage and the maximum output voltage rating would be very small. For example, Unisys Corporation requires the desired normal output voltage V1 requested by the load to be 12.2V, and requires the maximum output voltage rating of the power supply to be 12.4V, in which the gap between the desired normal output voltage and the maximum output voltage rating of the power supply is 0.2 only. In this way, the output voltage detected by an OVP comparator 214 of a conventional power supply 21 would be rated at as high as 12.56V, which is much higher than the maximum output voltage rating of 12.4V, and thereby the OVP function will be activated under this condition. Thus, the power supply cannot meet the requirements of allowing its output voltage to be 12.56V without activating the OVP function, which is set to react to the overvoltage problem at an output voltage of 12.4V. Moreover, the tolerance V of a conventional power supply that is equal to the gap between the output voltage detected by the OVP comparator 214 and the maximum output voltage rating is 0.36V, while a large percentage of the tolerance V is attributed to the voltage drop ΔVf across the forward-biased diode 213.

Therefore, the present invention is dedicated to meet the requirements that an OVP circuit can satisfy the requirements of outputting a voltage being higher than the maximum output voltage rating of power supply when that the gap between the desired normal output voltage and the maximum output voltage rating is relatively small, without activating the OVP function.

### SUMMARY OF THE INVENTION

A first object of the present invention is to develop an overvoltage protection circuit that enable a power supply to provide an output voltage being higher than its maximum output voltage rating by a relatively small gap without activating overvoltage protection function.

To attain the aforementioned object of the present invention, a first aspect of the present invention is focused on the provision of an overvoltage protection circuit for use in a power supply, wherein the power supply includes a voltage supply circuit and a diode having a first electrode and a second electrode. The overvoltage protection circuit is used to stop or reduce the output voltage of the voltage supply circuit when the output voltage of the voltage supply circuit is higher than a maximum output voltage rating of the voltage supply circuit. The overvoltage protection circuit includes: a first comparator electrically connected to the voltage supply circuit and the first electrode of the diode for detecting a first voltage at the first electrode of the diode and outputting a first detecting signal in response to a comparison between the first voltage and the maximum output voltage rating; a second comparator electrically connected to the second electrode of the diode for detecting a second voltage at the second electrode of the diode and outputting a second detecting signal in response to a comparison between the second voltage and the maximum output voltage rating; and a logic circuit electrically connected to the first comparator, the second comparator and the voltage supply circuit, and being used to receive the first detecting signal and the second detecting signal and output a control signal to control the voltage supply circuit to stop or reduce the output voltage when the first detecting signal and the second detecting signal indicate that both of the first voltage and the second voltage are higher than the maximum-output voltage rating.

In accordance with the present invention, the first electrode is an anode terminal of the diode and the second electrode is a cathode terminal of the diode.

In accordance with the present invention, the logic circuit is an AND gate which is used to control the voltage supply circuit to reduce its output voltage when both of the first voltage and the second voltage are higher than the maximum output voltage rating.

In accordance with the present invention, the first voltage is variable in accordance with a voltage drop as a result of the forward-biased characteristic of the diode, that is, the second voltage is obtained from subtracting the voltage drop across the forward-biased diode from the first voltage.

In accordance with the present invention, the overvoltage protection circuit further includes a latch electrically connected to the logic circuit and the voltage supply circuit, and being used to receive the control signal and turn off the voltage supply circuit by stopping or reducing the output voltage of the voltage supply circuit in response to the control signal.

In accordance with the present invention, the power supply is a redundant power supply.

In accordance with the present invention, the voltage supply circuit includes: a modulator for receiving a voltage and performs a modulation operation to a received voltage, and a filter electrically connected to the modulator for performing a filtering operation to a modulated voltage received from the modulator and outputting the first voltage.

In accordance with the present invention, the modulator is a pulse-width modulator (PWM) controller and the filter is a low-pass filter (LPF).

Another aspect of the present invention is associated with a power supply, comprising: a voltage supply circuit; a diode electrically connected to the voltage supply circuit and having a first electrode and a second electrode; and an overvoltage protection circuit electrically connected to the diode and the voltage supply circuit for stopping or reducing an output voltage of the voltage supply circuit when the output voltage of the voltage supply circuit is higher than a maximum output voltage rating of the voltage supply circuit. The overvoltage protection circuit includes: a first comparator electrically connected to the voltage supply circuit and the first electrode of the diode for detecting a first voltage at the first electrode of the diode and outputting a first detecting signal in response to a comparison between the first voltage and the maximum output voltage rating; a second comparator electrically connected to the second electrode of the diode for detecting a second voltage at the second electrode of the diode and outputting a second detecting signal in response to a comparison between the second voltage and the maximum output voltage rating; and a logic circuit electrically connected to the first comparator, the second comparator and the voltage supply circuit, and being used to receive the first detecting signal and the second detecting signal and output a control signal to control the voltage supply circuit to stop or reduce the output voltage when the first detecting signal and the second detecting signal indicate that both of the first voltage and the second voltage are higher than the maximum output voltage rating.

In accordance with the present invention, the power supply is a redundant power supply.

In accordance with the present invention, the voltage supply circuit includes: a modulator for receiving a voltage and performs a modulation operation to a received voltage, and a filter electrically connected to the modulator for performing a filtering operation to a modulated voltage received from the modulator and outputting the first voltage.

In accordance with the present invention, the modulator is a pulse-width modulator (PWM) controller and the filter is a low-pass filter (LPF).

In accordance with the present invention, the first electrode of the diode is an anode terminal of the diode, and the second electrode of the diode is a cathode terminal of the diode.

In accordance with the present invention, the logic circuit is carried out by an AND gate which is used to control the voltage supply circuit to stop or reduce the output voltage when both of the first voltage and the second voltage are higher than the maximum output voltage rating.

In accordance with the present invention, the first voltage is variable depending on the forward-biased characteristic of the diode, i.e. the second voltage is obtained by subtracting the voltage drop across the diode from the first voltage.

In accordance with the present invention, the overvoltage protection circuit includes a latch electrically connected to the logic circuit and the voltage supply circuit, wherein the latch is used to receive the control signal and turn off the voltage supply circuit by stopping or reducing the output voltage of the voltage supply circuit in response to the control signal.

Now the foregoing and other features and advantages of the present invention will be best understood through the following descriptions with reference to the accompanying drawings, wherein:

### BRIEF DESCRIPTION OF THE DRAWINGS

FIG. 1 is a timing diagram showing the output voltage waveform of a power supply under overvoltage protection;

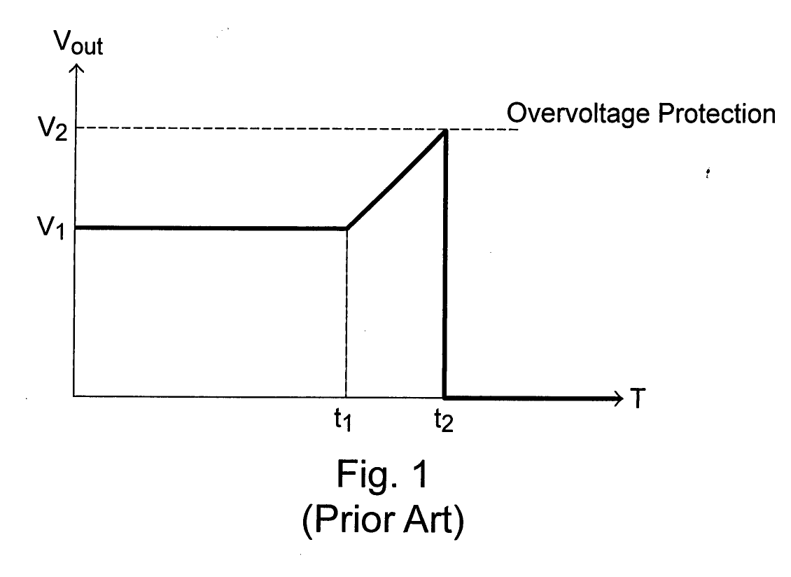

FIG. 2a is a circuit block diagram of a redundant power supply system according to the prior art;

FIG. 2b shows the output voltage waveforms of a power supply being measured by an OVP comparator according to the prior art;

FIG. 2c is an I-V characteristic scheme of a forward-biased diode;

FIG. 3a is a circuit block diagram of a redundant power supply according to a preferred embodiment of the present invention;

FIG. 3b is a circuit block diagram showing a power supply according to a preferred embodiment of the present invention; and

FIG. 3c shows the output voltage waveform of the voltage supply circuit being measured at the output terminal of the second OVP comparator.

### DETAILED DESCRIPTION OF THE PREFERRED EMBODIMENT

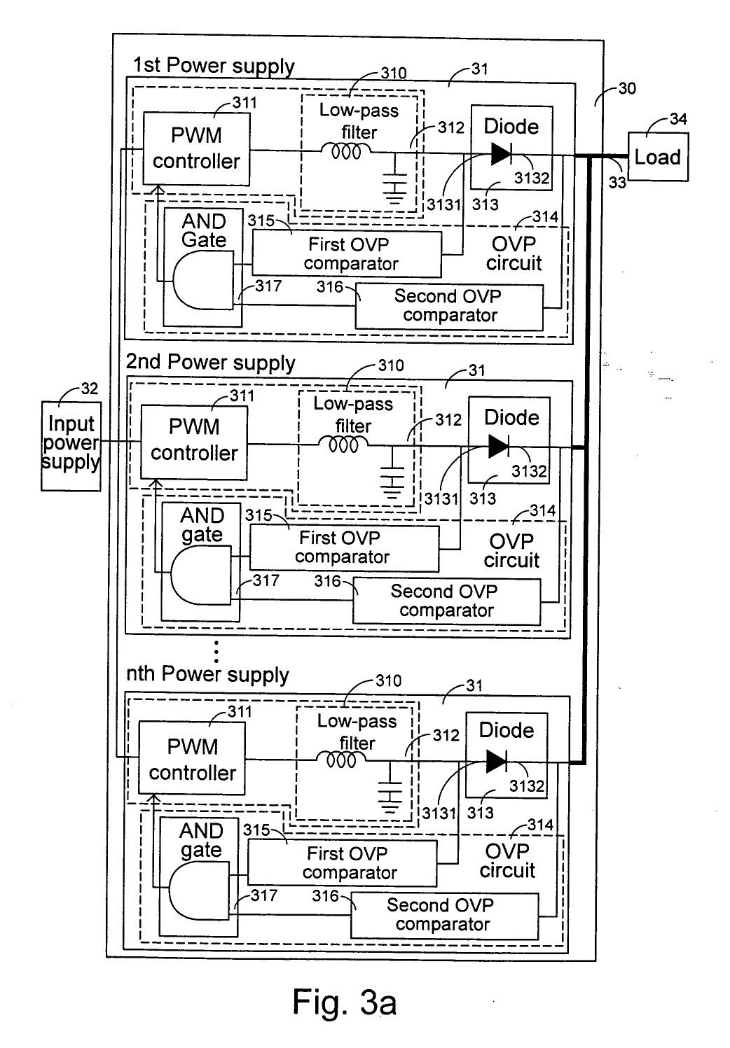

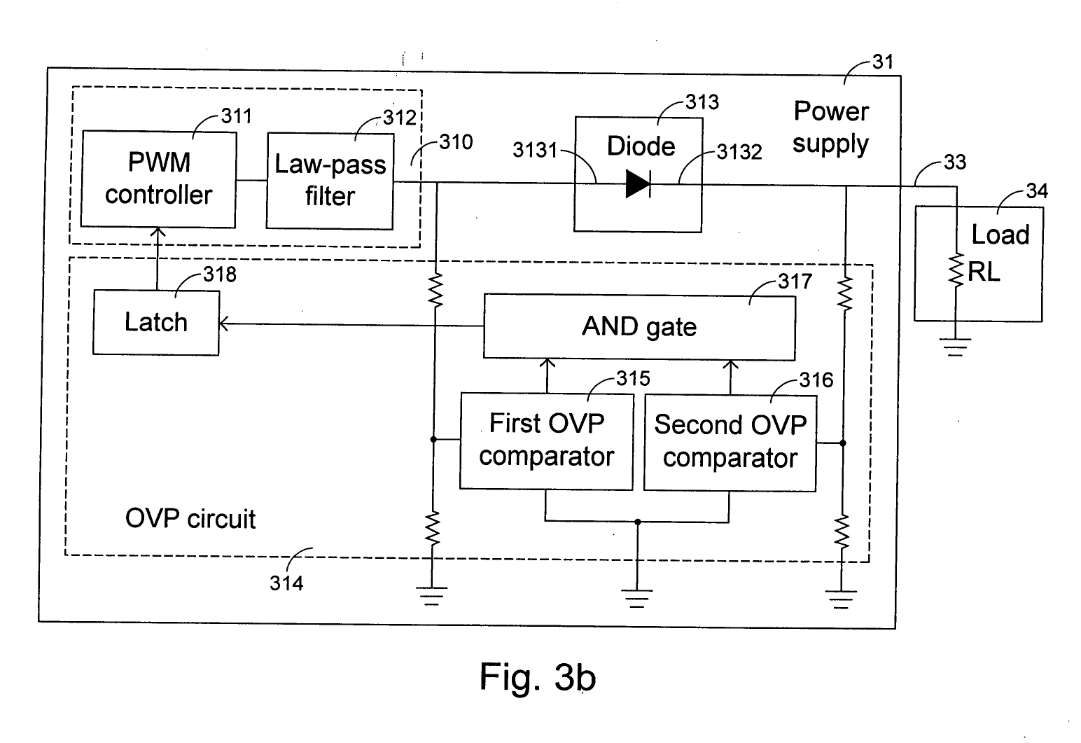

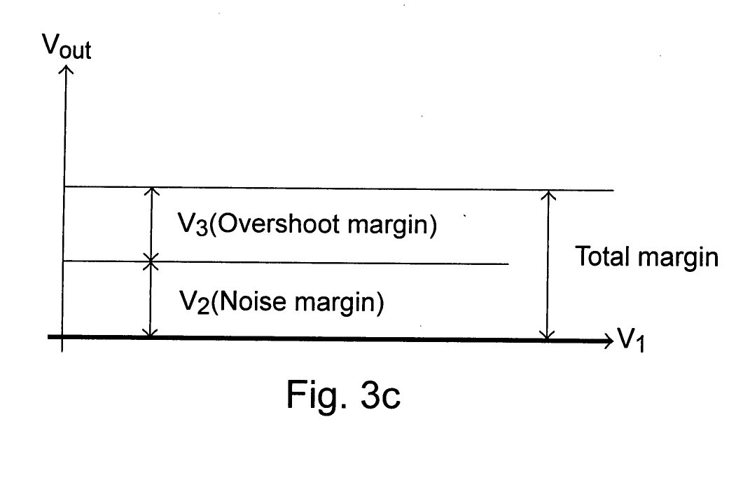

Referring to FIG. 3a, a redundant power supply according to a preferred embodiment of the present invention is illustrated. As indicated in FIG. 3a, a redundant power supply 30 is used to receive a predetermined input power from an input power source 32 and convert the input power into an output power tailored to power a load 34. The redundant power supply 30 includes n power supplies 31 and is used to provide an output DC power by a series of power conversion processes to power the load through an output voltage bus 33. The power supply 31 mainly includes a voltage supply circuit 310, a diode 313, and an OVP circuit 314.

The voltage supply circuit 310 is configured to supply electric power in accordance with the requirement of the load 34, wherein the voltage supply circuit 310 mainly includes a modulator and a filter. The modulator of the power supply circuit 310 is preferably made up of a PWM (pulse-width modulation) controller 311, and is used to perform a PWM modulation operation to the power supplied by the input power source 32. The filter of the voltage supply circuit 310 is a low-pass filter (LPF) 312, and is made up of an inductor and a capacitor, as shown in FIG. 3a. The filter is used to perform a filtering operation to the modulated pulse signals received from the PWM controller 311 and thereby generate an output DC voltage. The output DC voltage provided by the low-pass filter 312 is transferred to the load 34 via the diode 313 and the output voltage bus 33.

The diode 313 is electrically connected between the low-pass filter 312 and the output voltage bus 33, and includes a first electrode 3131 and a second electrode 3132. When the first electrode 3131 is applied with a positive voltage, a forward-biased current is induced and thus prevents the voltage supplied by other power supplies to be inputted via the second electrode 3132, and further protects other internal components of the power supply associated therewith. It should be noted that the first electrode 3131 is an anode terminal of the diode 313, and the second electrode 3132 is a cathode terminal of the diode 313.

The main function of the OVP circuit 314 is to instruct the voltage supply circuit 310 to stop or reduce the output voltage of the voltage supply circuit 310 when the output voltage exceeds a maximum output voltage rating. The core components of the OVP circuit 214 include a first comparator, a second comparator, and a logic circuit.

Turing to FIG. 3a and FIG. 3b, the first comparator is designated as a first OVP comparator 315, which is connected between the low-pass filter 312 and the first electrode 3131 of the diode 313. The first OVP comparator 315 is used to detect a first voltage being a fractional of the output voltage of the low-pass filter 312, i.e. the first voltage is the voltage measured at the first electrode 3131 of the diode 313. Also, the first OVP comparator 315 is configured to compare the first voltage with the maximum output voltage rating of the voltage supply circuit 310 and output a first detecting signal in response to the comparison between the first voltage and the maximum output voltage rating. Likewise, the second comparator is designated as a second OVP comparator 316, which is connected between the second electrode 3132 of the diode 313 and the output voltage bus 33, and is used to detect a second voltage being the voltage measured at the second electrode 3132 of the diode. Also, the second OVP comparator 316 is configured to compare the second voltage with the maximum output voltage rating and output a second detecting signal in response to the comparison between the second voltage and the maximum output voltage rating.

The logic circuit is electrically connected to the first OVP comparator 315, the second OVP comparator 316 and the PWM controller 311, and is preferably implemented by an AND gate 317. The logic circuit is used to receive the first detecting signal from the first OVP comparator 315 and also the second detecting signal from the second OVP comparator 316. The logic circuit is configured to output a control signal to regulate the PWM controller 311 to stop or reduce the output voltage of the voltage supply circuit 310 when the first detecting signal and the second detecting signal indicate that both of the first voltage and the second voltage exceed the maximum output voltage rating of the voltage supply circuit 310, and thereby protect the internal circuit components of the load 34.

Referring to FIG. 3b again, a latch 318 is further provided and connected between the AND gate 317 and the PWM controller 311 for receiving the control signal from the AND gate 317 and regulating the PWM controller 311 in response to the control signal, and thereby stop or reduce the output voltage of the voltage circuit 310.

When the first voltage is passed from the first electrode 3131 of the diode 313 to the second electrode 3132 of the diode 313, it will transit to a second voltage by the voltage drop ΔVf of the diode 313 as a result of the forward-biased characteristics of the diode 313, that is, the second voltage is obtained by subtracting the voltage drop ΔVf of the diode 313 from the first voltage. Because the OVP circuit 314 according to a preferred embodiment of the present invention is configured to measure the voltage at the first electrode 3131 of the diode 313 and the voltage at the second electrode 3132 of the diode 313, respectively, and uses the AND gate 317 to determine the occurrence of overvoltage problem, the influence caused by the voltage drop ΔVf of the diode can be obviated.

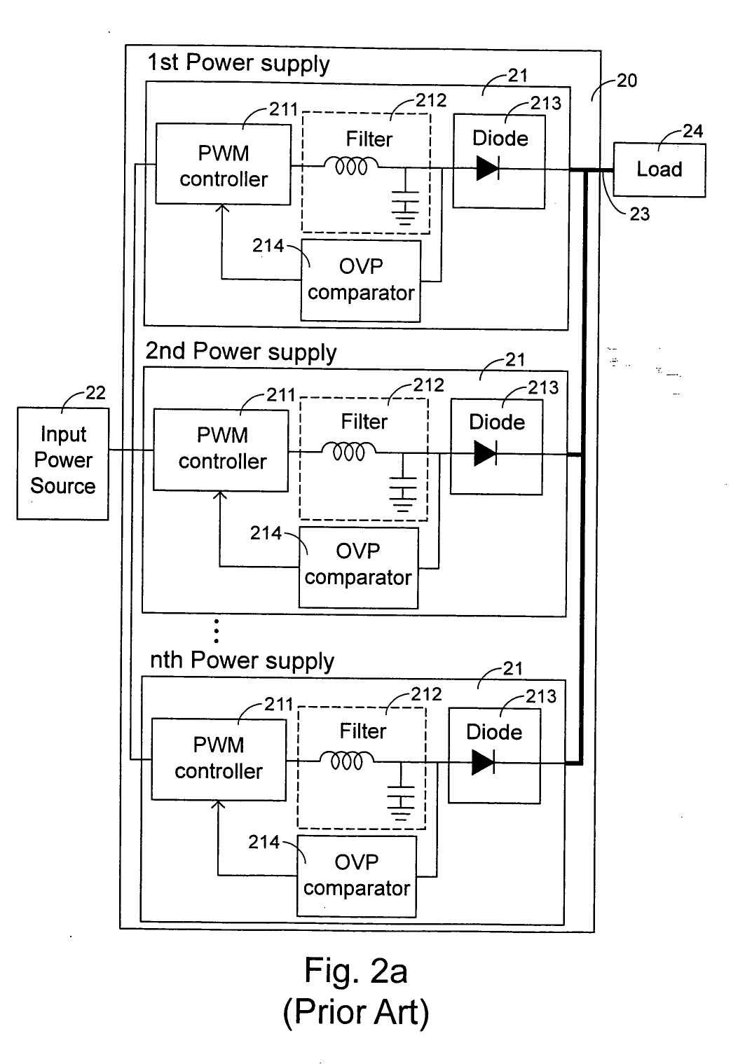

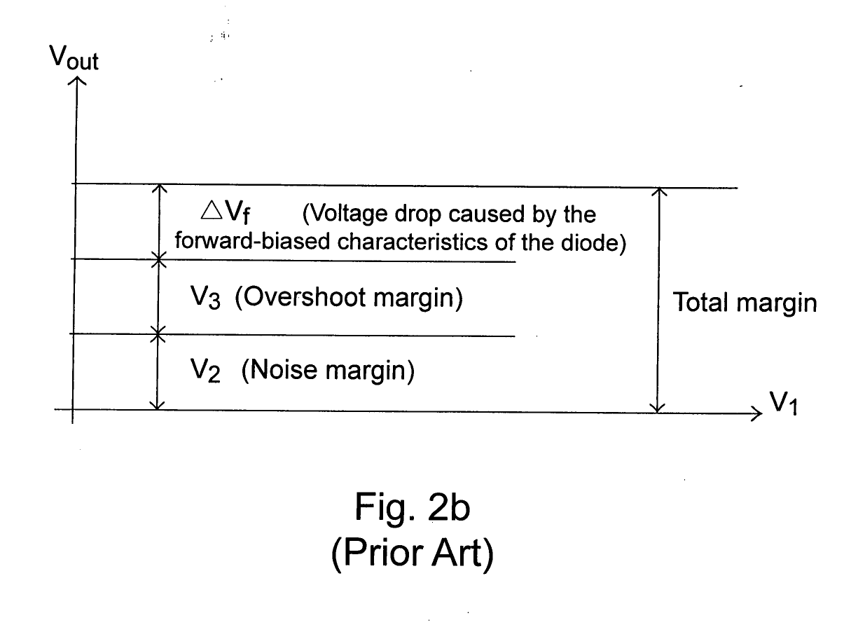

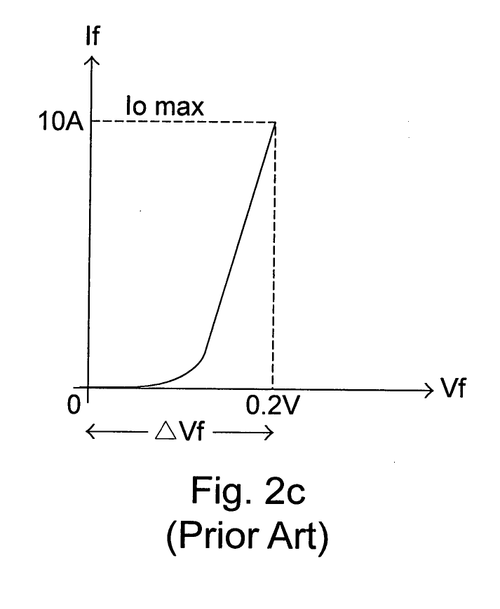

For example, if the desired output voltage V1 is 12.2V, and the maximum voltage rating is 12.4V, the first voltage measured by the first OVP comparator 315 is Vout1=V1+V2+V3+ΔVf=12.2+0.06+0.1+0.2=12.56, as shown in FIG. 2b. Because the second OVP comparator 316 ignores the voltage drop ΔVf as a result of the forward-biased characteristics of the diode 313, the second voltage is Vout2=V1+V2+V3+=12.2+0.06+0.1+=12.36, as shown in FIG. 3c. The resulting first voltage is 12.56V and thus exceeds the maximum voltage rating 12.4V, while the resulting second voltage is 12.36V and thus does not exceed the maximum voltage rating. Because the first voltage and the second voltage do not both exceed the maximum voltage rating, the AND gate 317 will not activate the overvoltage protection function.

In conclusion, the OVP circuit according to the present invention takes advantage of two OVP comparators to detect the voltage at the anode terminal and the cathode terminal of the diode, respectively, and thereby ignore the effect caused by the forward-biased voltage drop of the diode. In this manner, the requirement of enabling the redundant power supply to provide an output voltage being higher than its maximum output voltage rating without activating the OVP function can be satisfied, even if the gap between the actual output voltage and the maximum output voltage rating is relatively small.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

1. An overvoltage protection circuit for use in a power supply comprising a voltage supply circuit and a diode having a first electrode and a second electrode, wherein the overvoltage protection circuit is configured to restrain an output voltage of the voltage supply circuit when the output voltage exceeds a maximum output voltage rating, the overvoltage protection circuit comprising:
a first comparator electrically connected to the voltage supply circuit and the first electrode of the diode for detecting a first voltage at the first electrode of the diode and outputting a first detecting signal in response to a comparison between the first voltage and the maximum output voltage rating;
a second comparator electrically connected to the second electrode of the diode for detecting a second voltage at the second electrode of the diode and outputting a second detecting signal in response to a comparison between the second voltage and the maximum output voltage rating; and
a logic circuit electrically connected to the first comparator, the second comparator and the voltage supply circuit, wherein the logic circuit is used to receive the first detecting signal and the second detecting signal and configured to output a control signal to restrain the output voltage when the first detecting signal and the second detecting signal indicate that both of the first voltage and the second voltage exceed the maximum output voltage rating.

2. The overvoltage protection circuit according to claim 1 wherein the first electrode of the diode is an anode terminal thereof, and the second electrode of the diode is a cathode terminal thereof.

3. The overvoltage protection circuit according to claim 1 wherein the logic circuit is implemented by an AND gate.

4. The overvoltage protection circuit according to claim 1 wherein the first voltage is variable in accordance with a voltage drop of the diode as a result of the forward-biased characteristics of the diode, and the second voltage is obtained by subtracting the voltage drop of the diode from the first voltage.

5. The overvoltage protection circuit according to claim 1 wherein the overvoltage protection circuit includes a latch electrically connected to the logic circuit and the voltage supply circuit for receiving the control signal and turning off the voltage supply circuit in response of the control signal.

6. The overvoltage protection circuit according to claim 1 wherein the power supply is a redundant power supply.

7. The overvoltage protection circuit according to claim 1 wherein the voltage supply circuit comprises:
a modulator for receiving a voltage and performs a modulating operation to a received voltage; and
a filter electrically connected to the modulator for performing a filtering operation to a modulated voltage received from the modulator, and thereby outputting the first voltage.

8. The overvoltage protection circuit according to claim 7 wherein the modulator is a pulse-width modulation controller.

9. The overvoltage protection circuit according to claim 8 wherein the filter is a low-pass filter and is used to perform a filtering operation to the modulated voltage, and thereby output the first voltage.

10. A power supply comprising:
a voltage supply circuit;
a diode electrically connected to the voltage supply circuit and having a first electrode and a second electrode;
an overvoltage protection circuit electrically connected to the diode and the voltage supply circuit for stopping or reducing an output voltage of the voltage supply circuit when the output voltage of the voltage supply circuit is higher than a maximum output voltage rating of the voltage supply circuit, the overvoltage protection circuit comprising:
a first comparator electrically connected to the voltage supply circuit and the first electrode of the diode for detecting a first voltage at the first electrode of the diode and outputting a first detecting signal in response to a comparison between the first voltage and the maximum output voltage rating;
a second comparator electrically connected to the second electrode of the diode for detecting a second voltage at the second electrode of the diode and outputting a second detecting signal in response to a comparison between the second voltage and the maximum output voltage rating; and
a logic circuit electrically connected to the first comparator, the second comparator and the voltage supply circuit, and being used to receive the first detecting signal and the second detecting signal and output a control signal to control the voltage supply circuit to stop or reduce the output voltage when the first detecting signal and the second detecting signal indicate that both of the first voltage and the second voltage are higher than the maximum output voltage rating.

11. The power supply according to claim 10 wherein the power supply is a redundant power supply.

12. The power supply according to claim 10 wherein the voltage supply circuit comprises:
a modulator which receives a voltage and performs a modulating operation to a received voltage; and
a filter electrically connected to the modulator for performing a filtering operation to a modulated voltage received from the modulator, and thereby outputting the first voltage.

13. The power supply according to claim 12 wherein the modulator is a pulse-width modulation controller.

14. The power supply according to claim 12 wherein the filter is a low-pass filter for filtering the modulated voltage and thereby outputting the first voltage.

15. The power supply according to claim 10 wherein the first electrode of the diode is an anode terminal thereof and the second electrode of the diode is a cathode terminal thereof.

16. The power supply according to claim 10 wherein the logic circuit comprises an AND gate for controlling the voltage supply circuit to stop or reduce the output voltage when both of the first voltage and the second voltage exceed the maximum output voltage rating.

17. The power supply according to claim 10 wherein the first voltage is variable in accordance with a voltage drop of the diode as a result of the forward-biased characteristics of the diode, and the second voltage is obtained by subtracting the voltage drop of the diode from the first voltage.

18. The power supply according to claim 10 wherein the overvoltage protection circuit includes a latch electrically connected to the logic circuit and the voltage supply circuit for receiving the control signal and turning off the voltage supply circuit in response to the control signal.
